(19) United States
(12) Patent Application Publication
(10) Pub. No.: US 2026/0235826 A1
(43) Pub. Date: Aug. 13, 2026

(54) DIRECT ALIGNMENT STRUCTURES ON SILICON TO ENABLE PASSIVE SURFACE COUPLING

(71) Applicant: XILINX, INC., San Jose, CA (US)

(72) Inventors: Hao-Hsiang LIAO, Freemont, CA (US); Chuan XIE, Fremont, CA (US); Fang-Yu LIANG, Hsinchu City (TW); Suresh RAMALINGAM, Fremont, CA (US)

(21) Appl. No.: 19/412,781

(22) Filed: Dec. 8, 2025

Related U.S. Application Data
(60) Provisional application No. 63/755,934, filed on Feb. 7, 2025.

(51) Int. Cl. G02B 6/42

(52) U.S. Cl. CPC G02B 6/423; G02B 6/4206; G02B 6/4243; G02B 6/4292

(57) ABSTRACT

Plug and photonics IC (PIC) connection architectures and placement techniques are provided that provides improved placement accuracy. In one example, the plug and photonics IC (PIC) connection architecture includes a photonic integrated circuit (IC) assembly. The PIC assembly includes a photonic IC die and an optical coupler. The optical coupler has a top surface and a bottom surface. The bottom surface of the optical coupler is bonded to the photonic IC die. The top surface of the optical coupler has plug alignment structures disposed adjacent a lens of the optical coupler.

### CROSS REFERENCE TO RELATED APPLICATIONS

This application claims benefit of United States Provisional Patent Application No. 63/755,934, filed February 07, 2025, which is incorporated by reference in its entirety.

### FIELD

Embodiments of the present invention generally relates to co-package optics, and more particularly, to co-package optics having passive alignment structures.

### BACKGROUND

As bandwidth keeps increasing, co-package optics (CPO) is becoming a trend for artificial intelligence (AI) and high-performance computing (HPC), seeking to enhance data transferring rates and save power. In CPO, optical engine (OE), ASIC, GPU, chiplet and the like, are co-packaged on the same organic substrate as a photonics IC (PIC), which shortens interconnection route, helps to mitigate the degradation of high-frequency signal and saves overall power consumption. The number of OE modules depends on total bandwidth requirement. The more optical engines on the package, the more challenging packaging will be. In recent years, photonics I/O solutions have been developed rapidly. With requirement of high beach-front density of photonic integrated circuit (PIC), the optical couplers or fiber array units (FAUs) assemblies in a multi-chip-module (MCM) package has become a major manufacturing hurdle. The challenge in designing PIC with acceptable high beach-front density has become very time consuming, resulting in undesirably long product design timelines and increasing the associated costs.

Thus, there is a need for a new technique for connecting to a PIC.

### SUMMARY

Novel plug and photonics IC (PIC) connection architectures and placement techniques are provided that provides improved placement accuracy. In one example, the plug and PIC connection architecture is embodied as a photonic integrated circuit (IC) assembly. The PIC assembly includes a photonic IC die and an optical coupler. The optical coupler has a top surface and a bottom surface. The bottom surface of the optical coupler is bonded to the photonic IC die. The top surface of the optical coupler has plug alignment structures disposed adjacent a lens of the optical coupler.

The plug alignment structures extend above or are recessed in the top surface of the optical coupler.

In some examples, the top surface of the photonic IC die and the bottom surface of the optical coupler having mating die/coupler alignment structures.

In some examples, a plug retaining clamp is coupled to the top surface of the photonic IC die.

In another example, the plug and PIC connection architecture is embodied as a co-packaged integrated circuit (IC) device. The co-packaged IC device includes a substrate, at least one integrated circuit (IC) die, a photonic IC (PIC) die, and an optical coupler. The at least one IC die is mounted to a top surface of the substrate. The PIC die is mounted to the top surface of the substrate. The PIC die has a waveguide and photonic circuity. The photonic circuity of the PIC die is coupled to functional circuitry of the IC die through the substrate. The optical coupler has a top surface and a bottom surface. The bottom surface of the optical coupler is bonded to the PIC die. The top surface of the optical coupler has plug alignment structures disposed adjacent a lens of the optical coupler. The optical coupler is configured to couple light to the photonics circuitry of the photonic IC through the waveguide.

In still another example, a co-packaged integrated circuit (IC) device is provided. The co-packaged IC device includes a substrate, at least one integrated circuit (IC) die, a photonic IC (PIC) die, an optical coupler, and a plug. The least one IC die is mounted to a top surface of the substrate. The photonic PIC die is mounted to the top surface of the substrate. The photonic IC die has a waveguide and photonic circuity. The waveguide is configured to direct light to the photonic circuity. The photonic circuity is coupled to functional circuitry of the IC die through the substrate. The optical coupler has a top surface and a bottom surface. The bottom surface of the optical coupler and the PIC die have mating alignment structures that restrict lateral movement between the optical coupler and the PIC die. The top surface of the optical coupler has plug alignment structures disposed adjacent a lens of the optical coupler. The plug has coupler alignment structures disposed at an end of a spacer extending from a bottom surface of the plug that mate with the plug alignment structures of the coupler. The spacers set an air gap between the plug and coupler. The plug has a mirror positioned to direct light, from fiber optics terminating in the plug, between the coupler alignment structures through the lens of the coupler and to the waveguide of the PIC die.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic side view of one example of a photonics integrated circuit (PIC) assembly coupled with a plug of a fiber optics connector.

FIG. 2 is another view of the coupled plug and PIC assembly depicted in FIG. 1.

FIG. 3A is a schematic top view of the PIC assembly depicted in FIG. 1 with the plug removed.

FIG. 3B is a schematic top view of the coupled plug and PIC assembly depicted in FIG. 1.

FIG. 4 is a schematic side view of another example of a photonics integrated circuit (PIC) assembly coupled with a plug of a fiber optics connector.

FIG. 5 is another view of the coupled plug and PIC assembly depicted in FIG. 4.

FIGS. 6A is a schematic top view of the PIC assembly depicted in FIG. 4 with the plug removed.

FIG. 6B is a schematic top view of the coupled plug and PIC assembly depicted in FIG. 4.

FIG. 7 is a schematic side view of one example of an electronic device having a chip package that includes a PIC assembly coupled with a plug of a fiber optics connector.

To facilitate understanding, identical reference numerals have been used, where possible, to designate identical elements that are common to the figures. It is contemplated that elements of one embodiment may be beneficially incorporated in other embodiments.

### DETAILED DESCRIPTION

Disclosed are novel plug and photonics IC (PIC) connection architectures and placement techniques that provides improved placement accuracy. The techniques disclosed herein mitigate problems associated with beach-front density in PIC designs by improving alignment between components. Direct fine alignment structures on silicon surface of the PIC die enable surface coupling between the optical coupler and the PIC die to form a photonic integrated circuit (PIC) assembly. Direct fine alignment structures between the PIC assembly and fiber optic plug also provides passive alignment between these components. One or both of these alignment structures may be utilized to improve optical-performance, shorten process flow and reduce the need for high-precision equipment investment.

In one example, the top silicon surface of the PIC die provides greater area for utilizing alignment structures as compared to the side of the silicon. The direct alignment structures are easily integrated and precisely formed on the top surface of the silicon PIC die. The alignment structures can alternatively be formed on the top surface of a coupler mounted on the PIC. This enables an enlarged mode field diameter (MFD) to desirably gain larger mechanical and assembly tolerances.

A plug include complimentary alignment structures that mates with the alignment structures formed in the PIC die or coupler. The alignment structures may mate in a way that sets the spacing between the optics of the plug and coupler at a distance that enhances efficient transfer of light between the plug and coupler, and ultimately to the grating of the waveguide disposed in the PIC die.

The alignment structures provides passive alignment between the PIC assembly and fiber plug. The fine alignment structures may be directly written on the silicon material of the PIC die which enhances optical performance by eliminating additional optical part and assembly steps. The alignment structures also helps shrink the co-package optics link bulge. The alignment structures directly positioned on silicon allows a cost effective and precise alignment between the plug and lens of the coupler and/or grating of the PIC waveguide. Moreover, optical parts, such as receptacles or fine positioners may be eliminated. Furthermore, the process flow time and costs reduced, while the overall yield and through-put is beneficially increased.

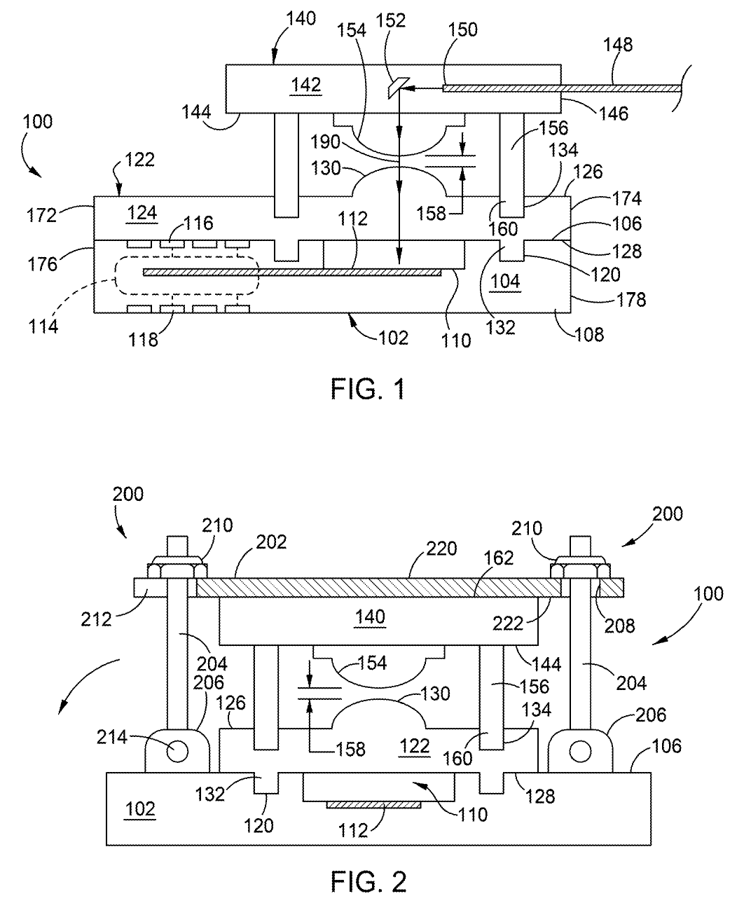

Turning now to FIG. 1, a schematic side view of one example of a photonics integrated circuit (PIC) assembly 100 coupled with a plug 140 of a fiber optics connector is illustrated. The PIC assembly 100 includes a photonics coupler 122 mounted on a photonics integrated circuit (PIC) die 102. The photonics coupler 122 may be secured to the PIC die 102 utilizing clamps, adhesives, or other suitable technique. In the example depicted in FIG. 1, the photonics coupler 122 is bonded to the PIC die 102 using a UV curing or other suitable adhesive.

The PIC die 102 includes a die body 104. The die body 104 has a top surface 106 and a bottom surface 108. The PIC die 102 also has four sidewalls that couple the top and bottom surfaces 106, 108 to form a rectangular shape. In FIG. 1, sidewall 176 is shown facing away from sidewall 178.

A recess 110 is formed in the top surface 106 of the die body 104. A waveguide 112 is exposed in the bottom of the recess 110. The waveguide 112 is coupled to photonics circuitry 114 that is also disposed in the die body 104. The photonics circuitry 114 is coupled to contact pads formed on the top and or bottom surfaces 106, 108 of the die body 104. In the example depicted in FIG. 1, contact pads 116 are shown exposed on the top surface 106 of the die body 104, while contact pads 118 are shown exposed on the bottom surface 108 of the die body 104.

The photonics circuitry 114 may include one or more lasers, optical amplifiers, modulators, filters, splitters and resonators. The photonics circuitry 114 is coupled to the waveguide 112 that provides routing for optical signals into and out of the photonics circuitry 114. The photonics circuitry 114 is also coupled to contact pads 118 formed on at least one of the top and bottom surfaces 106, 108 of the PIC die 102.

A recess 110 formed in the top surface 106 of the PIC die 102. The recess 110 is disposed below and aligned with a lens 130 of the coupler 122. Adjacent the recess 110, one or more alignment structures 120 are formed in the top surface 106 of the PIC assembly 100. In the example depicted in FIG. 1, the alignment structures 120 are in the form of an aperture that is configured to receive a mating alignment structure 132 extending from a bottom surface 128 of the coupler 122. It is contemplated that other mating geometry may be utilized for the alignment structures 120, 132, and that the alignment structures 120 may alternatively extend from the PIC die 102 and the complimentary mating alignment structures 132 may be recessed into the bottom surface 128 of the coupler 122.

The coupler 122 includes a coupler body 124. The coupler body 124 is generally fabricated from suitable for optical coupling with the PIC die 102. The coupler body 124 may be fabricated from UV fused silica, gradient index glass (GRIN), Lanthanum dense flint glass, and other suitable polymers, epoxies, and glasses.

The coupler body 124 has a top surface 126 and a bottom surface 128. The coupler body 124 also has four sidewalls that couple the top and bottom surfaces 126, 128 to form a rectangular shape. In FIG. 1, one sidewall 172 of the coupler body 124 is shown facing away from another sidewall 174. The coupler body 124 may be the same size or smaller than the die body 104. In the example depicted in FIG. 1, the sidewalls 172, 174 of the coupler body 124 are vertically aligned with the sidewalls 176, 178 of the die body 104.

As briefly mentioned above, the lens 130 is disposed above and aligned with the recess 110 formed in the die body 104. The lens 130 extends from the top surface 126 of the coupler body 124. Alignment structures 134 also extend into the top surface 126 of the coupler body 124. The alignment structures 134 generally are disposed adjacent to the lens 130. For example, the coupler 122 may include two alignment structures 134, one disposed on opposite sides of the lens 130. In another example, the coupler 122 may include three, four or more alignment structures 134 that are positioned around the lens 130, for example on a common radius relative to a centerline of the lens 130.

In the example depicted in FIG. 1, the alignment structures 134 are in the form of an aperture that is configured to receive a mating alignment structure 160 extending from a bottom surface 144 of the plug 140. The aperture forming the alignment structure 134 may have a circular, square, rectangular, hexagonal, polygonal, oblong, or other suitable shape. Alternatively, aperture forming the alignment structure 134 may be a trench, while the mating alignment structure 160 may be a rib or other projection that closely fits with the trench, such as a row of posts.

The plug 140 includes a plug body 142. The plug body 142 may be formed from any suitable material. The plug body 142 includes a bottom surface 144 and a top surface 162. The plug body 142 provides a termination 150 one or more optical fibers 148 that extend into the plug body 142 from a side surface 146. The optical fiber 148 emits light from the termination 150 which impinges on a mirror 152 disposed in the plug body 142. The mirror 152 redirects the light through a lens 154 that is disposed on the bottom surface 144 of the plug body 142.

As briefly discussed above, the alignment structures 160 extend from the bottom surface 144 of the plug body 142. The alignment structures 160 may be disposed at the distal end of a spacer 156. The length of the spacers 156 set the distance that the bottom surface 144 of the plug body 142 is spaced from the top surface 126 of the coupler 122. In this manner, the spacers 156 said the distance across an air gap 158 which is defined between the phasing surfaces of the lens 130 of the coupler 122 and the lens 154 of the plug 140. In one example, the spacers 156 are in the form of a post.

The alignment structure 160 at the end of each spacer 156 has shape that is complimentary to the alignment structure 134 of the coupler 122. That is, the alignment structures 134, 160 has a geometry that allows one alignment structure to closely slip within the other alignment structure, thus preventing lateral movement of the plug 140 relative to the PIC assembly 100, ensuring alignment of the lenses 130, 154 and reliable transmission of light from the optical fibers 148 and the grating of the waveguide 112 exposed in PIC die 102.

FIG. 2 is another side view of the coupled plug 140 and PIC assembly 100 depicted in FIG. 1. The plug 140 may be secured to the PIC assembly 100 by any suitable technique. For example, the plug 140 may be secured to the PIC assembly 100 using fasteners, clamps, clips, or adhesives, among others. In the example depicted in FIG. 2, the plug 140 is secured to the PIC assembly 100 by at least one clamp 200.

The clamp 200 includes a bar 202 that is secured to the top surface 106 of the PIC die 102 (or underlying PCB or other underlying substrate) by fasteners 204. The bar 202 is disposed over and in contact with the top surface 162 of the plug 140. One end of the fastener 204 may be coupled to the top surface 106 of the PIC die 102 by any suitable technique. In one example, an end of the fastener 204 is connected to a bracket 206 that is mounted to the top surface 106 of the die body 104. The fastener 204 may be connected to the bracket 206 using a pin 214, or other device. The opposite end of the fastener 204 extends through the bar 202, where a nut 210 may be threaded onto the fastener 204 to engage the bar 202, thus urging the bar 202 towards the PIC die 102 and clamping the plug 140 securely against the coupler 122 disposed on the PIC die 102. The spacers 156 prevent the bar 202 from moving the plug 140 closer than a determined distance from the coupler 122, thus setting the distance defining the air gap 158 defined between the lenses 130, 154, which improves light transmission.

In one example, one of the fasteners 204 extends through a hole 208 formed in one end of the bar 202. The fastener 204 on the other side of the plug 140 extends through a slot 212 formed in the opposite end of the bar 202. When the nut 210 is sufficiently loosened, the fastener 204 may be rotated about the pin 214 coupling the fastener 204 to the bracket 206, allowing the fastener 204 to rotate out of the slot 212 and the bar 202 to move clear from over the plug 140, thus allowing the unclamped plug 140 to be freely disengaged from the PIC assembly 100.

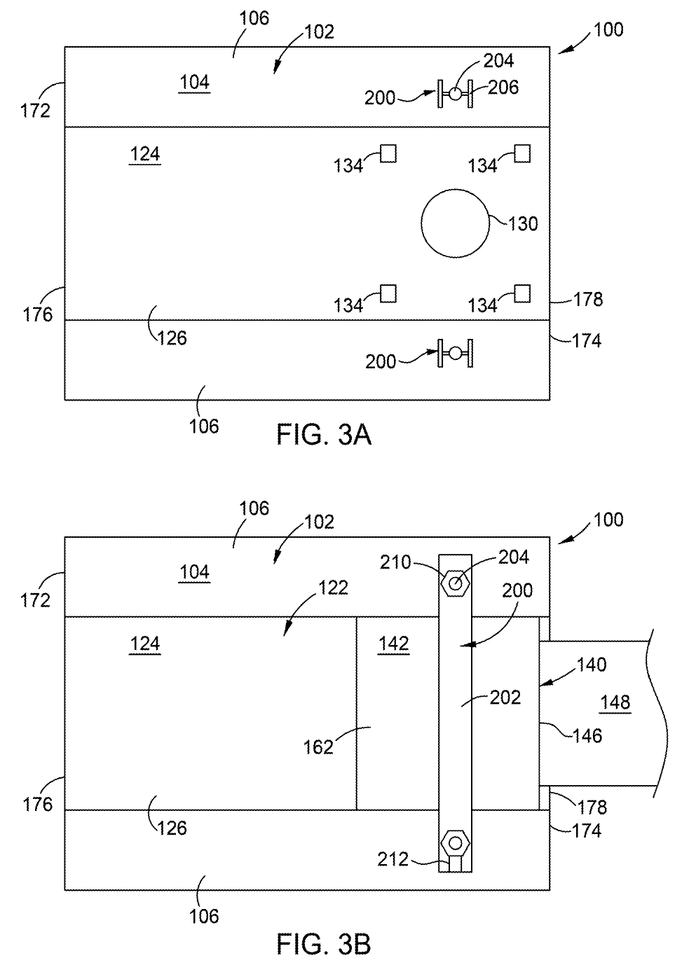

FIG. 3A is a schematic top view of the PIC assembly 100 depicted in FIG. 1 with the plug 140 removed to better view the alignment structures 134 formed in the top surface 126 of the coupler 122. As shown in FIG. 3A, the alignment structures 134 are arranged outward of the lens 130. In one example, the alignment structures 134 are disposed on opposing sides of the lens 130. In another example, the alignment structures 134 are disposed around the lens 130. Although 4 alignment structures 134 are shown disposed on a bolt circle centered around the lens 130, other suitable numbers or arrangements of alignment structures 134 may alternatively be utilized.

Although not shown in FIG. 3A, the alignment structures 160 of the plug 140 are arranged in the mirror image of the alignment structures 134 of the coupler 122 such that the alignment structures 132, 160 slide one inside the other when the plug 140 is securely engaged with the coupler 122. The mating engagement of the alignment structures 132, 160 prevents lateral movement of the plug 140 relative the coupler 122, thus advantageously ensuring good optical alignment (i.e., transmission) between components.

FIG. 3B is a schematic top view of the coupled plug 140 and PIC assembly 100 depicted in FIG. 1. In FIG. 3B, the bar 202 is shown extending across the plug 140, thereby securing the plug 140 to the PIC assembly 100.

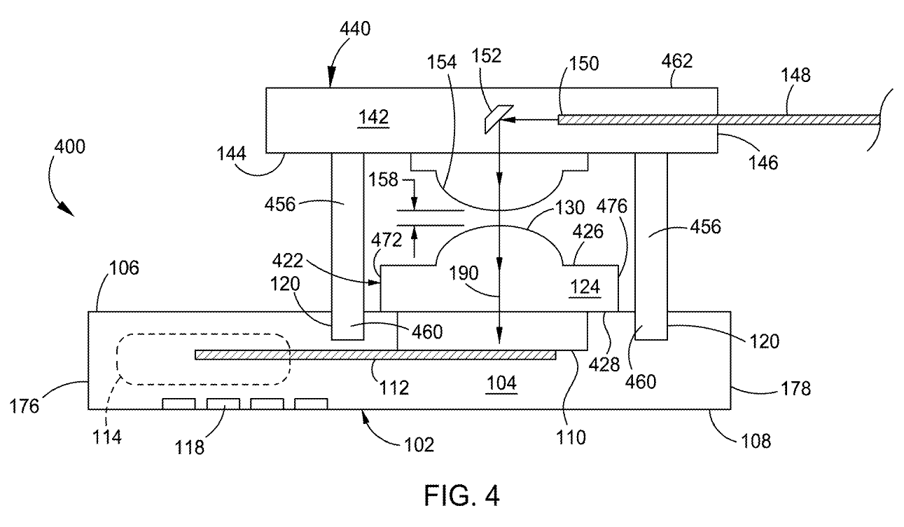

FIG. 4, a schematic side view of another example of a photonics integrated circuit (PIC) assembly 400 coupled with a plug 440 of a fiber optics connector. The PIC assembly 100 is generally similar to the PIC assembly 100 discussed above, except in that a coupler 422 of the PIC assembly 400 is smaller than the coupler 122 utilized in the PIC assembly 100, thus allowing the alignment structures 460 of the plug 440 to directly engage the complimentary alignment structures 120 formed in a PIC die 102 of the PIC assembly 400.

As with the PIC assembly 100, the photonics coupler 422 is mounted on the PIC die 102. The photonics coupler 422 may be secured to the PIC die 102 utilizing clamps, adhesives, or other suitable technique. In the example depicted in FIG. 4, the photonics coupler 422 is secured to the PIC die 102 using a UV curing adhesive.

The PIC die 102 includes a die body 104. The die body 104 has a top surface 106 and a bottom surface 108. The PIC die 102 also has four sidewalls that couple the top and bottom surfaces 106, 108 to form a rectangular shape. In FIG. 4, sidewall 476 is shown facing away from sidewall 178.

A recess 110 is formed in the top surface 106 of the die body 104. A waveguide 112 is exposed in the bottom of the recess 110. The waveguide 112 is coupled to photonics circuitry 114 that is also disposed in the die body 104. The photonics circuitry 114 is coupled to contact pads formed on the top and or bottom surfaces 106, 108 of the die body 104. In the example depicted in FIG. 4, contact pads 118 are shown exposed on the bottom surface 108 of the die body 104.

The photonics circuitry 114 may include one or more lasers, optical amplifiers, modulators, filters, splitters and resonators. The photonics circuitry 114 is coupled to the waveguide 112 that provides routing for optical signals into and out of the photonics circuitry 114. The photonics circuitry 114 is also coupled to contact pads 118 formed on at least one of the top and bottom surfaces 106, 108 of the PIC die 102.

Although not shown in FIG. 4, the coupler 422 and PIC die 102 may include complimentary alignment structures, such as depicted in the PIC assembly 100 illustrated in FIG. 1.

A recess 110 formed in the top surface 106 of the PIC die 102. The recess 110 is disposed below and aligned with a lens 130 of the coupler 422. Adjacent the recess 110, one or more alignment structures 120 are formed in the top surface 106 of the PIC assembly 400. In the example depicted in FIG. 4, the alignment structures 120 are in the form of an aperture that is configured to receive a mating alignment structure 460 extending from a bottom surface 144 of a plug 440 of the fiber optics connector. It is contemplated that other mating geometry may be utilized for the alignment structures 120, 460, and that the alignment structures 120 may alternatively extend from the PIC die 102 and the complimentary mating alignment structures 460 may be recessed into the bottom surface 144 of the plug 440.

In the example depicted in FIG. 4, the alignment structures 120 are in the form of an aperture that is configured to receive a mating alignment structure 460 extending from the bottom surface 144 of the plug 440. The aperture forming the alignment structure 120 may have a circular, square, rectangular, hexagonal, polygonal, oblong, or other suitable shape. Alternatively, aperture forming the alignment structure 120 may be a trench, while the mating alignment structure 460 may be a rib or other projection that closely fits with the trench, such as a row of posts.

The coupler 422 includes a coupler body 124. The coupler body 124 is generally fabricated from suitable for optical coupling with the PIC die 102. The coupler body 124 may be fabricated from UV fused silica, gradient index glass (GRIN), Lanthanum dense flint glass, and other suitable polymers, epoxies, and glasses.

The coupler body 124 has a top surface 426 and a bottom surface 428. The coupler body 124 also has four sidewalls that couple the top and bottom surfaces 426, 428 to form a rectangular shape. In FIG. 4, one sidewall 472 of the coupler body 124 is shown facing away from another sidewall 174. The coupler body 124 is smaller than the die body 104. In the example depicted in FIG. 4, the sidewalls 472, 174 of the coupler body 124 are dispose inward from the sidewalls 476, 178 of the die body 104.

As briefly mentioned above, the lens 130 is disposed above and aligned with the recess 110 formed in the die body 104. The lens 130 extends from the top surface 126 of the coupler body 124.

The plug 440 includes a plug body 142. The plug body 142 may be formed from any suitable material. The plug body 142 includes a bottom surface 144 and a top surface 462. The plug body 142 provides a termination 150 one or more optical fibers 148 that extend into the plug body 442 from a side surface 146. The optical fiber 148 emits light from the termination 150 which impinges on a mirror 152 disposed in the plug body 142. The mirror 152 redirects the light through a lens 154 that is disposed on the bottom surface 144 of the plug body 142.

As briefly discussed above, the alignment structures 460 extend from the bottom surface 144 of the plug body 142. The alignment structures 460 may be disposed at the distal end of a spacer 456. The length of the spacers 456 set the distance that the bottom surface 144 of the plug body 142 is spaced from the top surface 426 of the coupler 422. In this manner, the spacers 456 said the distance across an air gap 158 which is defined between the phasing surfaces of the lens 130 of the coupler 422 and the lens 154 of the plug 440. In one example, the spacers 456 are in the form of a post.

The alignment structure 460 at the end of each spacer 456 has shape that is complimentary to the alignment structure 120 of the PIC die 102. That is, the alignment structures 120, 460 has a geometry that allows one alignment structure to closely slip within the other alignment structure, thus preventing lateral movement of the plug 440 relative to the PIC assembly 400, ensuring alignment of the lenses 130, 154 and reliable transmission of light from the optical fibers 148 and the grating of the waveguide 112 exposed in PIC die 102.

Alignment structures 460 and spacers 456 generally pass outward of the coupler 422. For example, the plug 440 may include two alignment structures 460, one disposed on opposite sides of the coupler 422 (and consequently, opposite sides of the lens 130 of the coupler 422). In another example, the plug 440 may include three, four or more alignment structures 460 that are positioned outward of and around the coupler 422, for example on a common radius relative to a centerline of the lens 130 of the coupler 422.

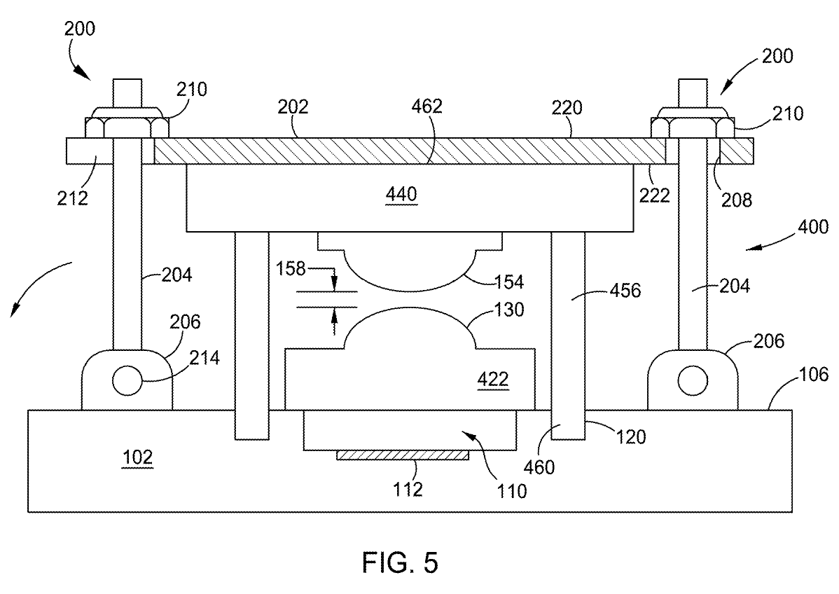

FIG. 5 is another side view of the coupled plug 440 and PIC assembly 400 depicted in FIG. 4. The plug 440 may be secured to the PIC assembly 400 by any suitable technique. For example, the plug 440 may be secured to the PIC assembly 400 using fasteners, clamps, clips, or adhesives, among others. In the example depicted in FIG. 5, the plug 440 is secured to the PIC assembly 400 by at least one clamp 200.

The clamp 200 includes a bar 202 that is secured to the top surface 106 of the PIC die 102 by fasteners 204. The bar 202 is disposed over and in contact with the top surface 462 of the plug 440. One end of the fastener 204 may be coupled to the top surface 106 of the PIC die 102 by any suitable technique. In one example, an end of the fastener 204 is connected to a bracket 206 that is mounted to the top surface 106 of the die body 104. The fastener 204 may be connected to the bracket 206 using a pin 214, or other device. The opposite end of the fastener 204 extends through the bar 202, where a nut 210 may be threaded onto the fastener 204 to engage the bar 202, thus urging the bar 202 towards the PIC die 102, thus holding the plug 440 against the coupler 422 disposed on the PIC die 102. The spacers 456 prevent the bar 202 from moving the plug 440 closer than a determined distance from the coupler 422, thus setting the distance defining the air gap 158 defined between the lenses 130, 154.

In one example, one of the fasteners 204 extends through a hole 208 formed in one end of the bar 202. The fastener 204 on the other side of the plug 440 extends through a slot 212 formed in the opposite end of the bar 202. When the nut 210 is sufficiently loosened, the fastener 204 may be rotated about the pin 214 coupling the fastener 204 to the bracket 214 to allow the fastener 204 to rotate out of the slot 212 and the bar 202 remove from over the plug 440, thus allowing the plug 440 to be freely disengaged from the PIC assembly 400.

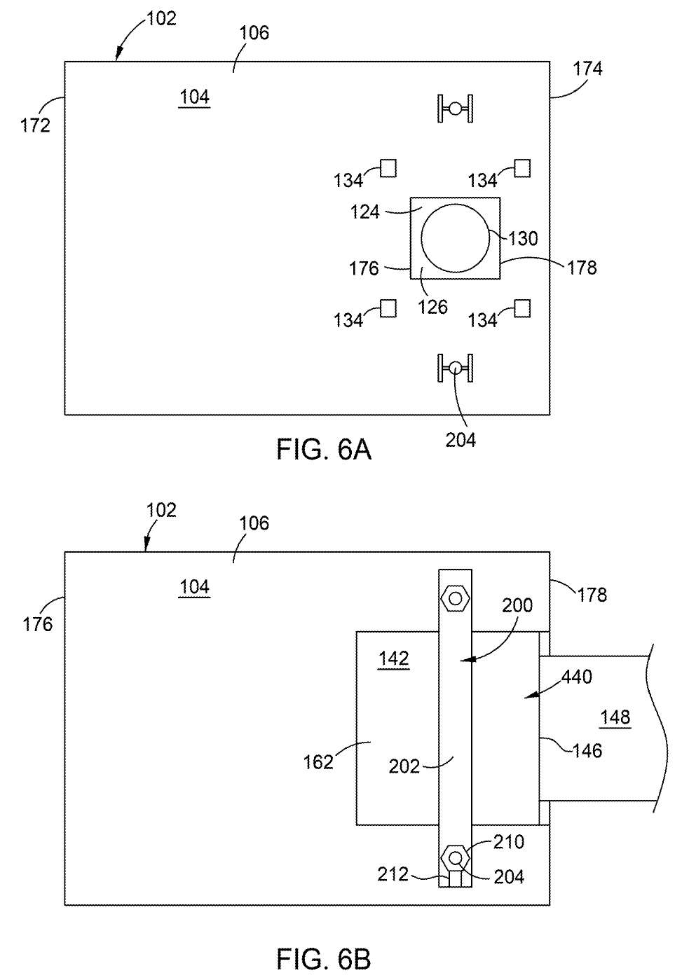

FIG. 6A is a schematic top view of the PIC assembly 400 depicted in FIG. 4 with the plug 440 removed to better view the alignment structures 120 formed in the top surface 106 of the PIC die 102. As shown in FIG. 6A, the alignment structures 120 are arranged outward of the recess 110 (and coupler 422). In one example, the alignment structures 120 are disposed on opposing sides of the recess 110 (and coupler 422, and lens 130 of the coupler 422). In another example, the alignment structures 120 are disposed around the recess 110 (and coupler 422, and lens 130 of the coupler 422). Although 4 alignment structures 120 are shown disposed on a bolt circle centered around recess 110 (and coupler 422, and lens 130 of the coupler 422), other suitable numbers or arrangement of alignment structures 120 may be alternatively utilized.

Although not shown in FIG. 6A, the alignment structures 460 of the plug 440 are arranged in the mirror image of the alignment structures 120 of the PIC die 102 such that alignment structures 120, 460 slide one inside the other when the plug 440 is securely engaged with the PIC die 102, such that the plug 440 sandwiches the coupler 422 against the PIC die 102.

FIG. 6B is a schematic top view of the coupled plug 440 and PIC assembly 400 depicted in FIG. 4. In FIG. 6B, the bar 202 is shown extending across the plug 440, thereby securing the plug 440 to the PIC assembly 400.

The alignment structures discussed above will not only enable accurate positioning in X and Y axes, but also enables the spacing of the coupler/lens relative to the PIC/grating in the Z axis to be precisely set by the depth of trench and the length of the alignment structures. In FIGS. 3A and 6A, four alignment structures are illustrated, but a different number of alignment structures may alternatively be utilized, for example one or more. The number, location and sectional profile of the mating alignment structures may also be selected to assist positioning of the coupler/lens relative to the PIC/grating. In one example, the sectional profile of the alignment structure may be polygonal or oblong.

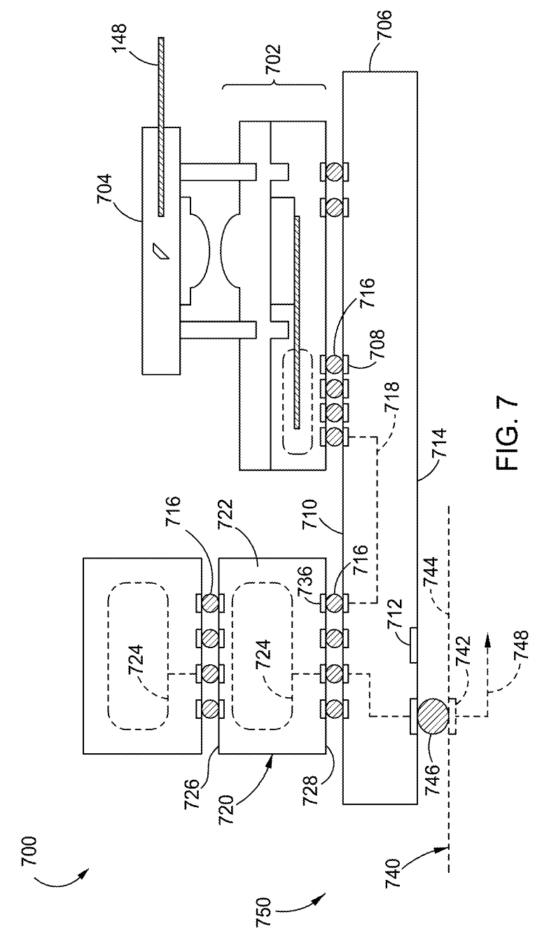

FIG. 7 is a schematic side view of one example of an electronic device 750 having co-packaged integrated circuit (IC) device 700 that includes a PIC assembly 702 coupled with a plug 704 of a fiber optics connector. The PIC assembly 702 and plug 704 may be configured as described above with reference to the PIC assemblies 100, 400 and plugs 140, 440, or other suitable PIC assembly and plug.

The co-packaged IC device 700 includes a package substrate 706 having the PIC assembly 702 and one or more IC dies 720 mounted thereon. The PIC assembly 702 may be electrically and mechanically coupled to the package substrate 706 via solder interconnects 716. The solder interconnects 716 couple the photonics circuitry of the PIC assembly 702 to contact pads 708 formed on the top surface of the package substrate 706.

Each of the one or more IC dies 720 of the co-packaged IC device 700 includes a die body 722. The die body 722 has a top surface 726 and a bottom surface 728. Functional circuitry 724 is disposed in the die body 722 and may be configured to perform logic or memory tasks, among other solid state computing tasks. The functional circuitry 724 terminates at contact pads 730 formed on the top and/or bottom surfaces 726, 728 of the die body 722. The functional circuity 724 may be configured as a memory die, a CPU die, a GPU die, or other type of IC die. The functional circuity 724 of least one of the IC dies 720 includes trans-impedance amplifiers and drivers for amplification of the signals outputted from the photonics circuitry of the PIC die of the PIC assembly 702.

The one or more IC dies 720 are electrically and mechanically coupled to the package substrate 706. In one example, the one or more IC dies 720 are electrically and mechanically coupled to the package substrate 706 via solder interconnects 716. The solder interconnects 716 couple the functional circuitry 722 of the IC dies 720 to contact pads 708 formed on the top surface of the package substrate 706. Alternatively, the PIC assembly 702 and/or IC die 720 may be coupled to the package substrate 706 via hybrid bonding or other suitable technique.

The package substrate 706 include routing circuitry 718, some of which that terminates at the contact pads 716, and other of which terminates at contact pads 712. The routing circuitry 718 allow electronic communication between the functional circuitry of the IC dies 720 and the photonics circuitry of the PIC assembly 702. The contact pads 712 facilitate connecting the co-packaged IC device 700 to a printed circuitry board (PCB) 740, forming the electronic device 750. In the example depicted in FIG. 7, the contact pads 712 are connected by solder balls 746 to contact pads 742 exposed on a top surface 744 of the PCB 740. The contact pads 742 of the PCB 740 are connected to routing circuitry 748 formed in or on the PCB 740.

The optical fibers 148 are coupled to the PIC assembly 702 via a plug 440. The PIC assembly 702 and the plug 440 leverage alignment structures as described above to ensure placement accuracy of components, while also ensuring good light transmission.

Thus, a plug and photonics IC (PIC) connection architecture and placement technique has been disclosed above that provides improved placement accuracy. The plug and PIC connection architecture mitigates the problems associated with beach-front density in PIC designs. The alignment structures enable a passive surface coupling between the plug and PIC assembly that comprises an optical coupler and PIC die. These alignment structures improve optical-performance, shorten process flow and reduce the need for high-precision equipment investment.

The alignment structures enhance optical performance by eliminating additional optical part and assembly steps. The alignment structures also helps shrink the co-package optics link bulge. The alignment structures directly positioned on silicon allows a cost effective and precise alignment between the plug and lens of the coupler and/or grating of the PIC waveguide. Moreover, optical parts, such as receptacles or fine positioners may be eliminated. Furthermore, the process flow time and costs reduced, while the overall yield and through-put is beneficially increased.

The above described technology may be expressed by one or more of the following non-limiting examples.

Example 1. A photonic integrated circuit (IC) assembly including: a photonic IC die; and an optical coupler having a top surface and a bottom surface, the bottom surface of the optical coupler bonded to the photonic IC die, the top surface of the optical coupler having plug alignment structures disposed adjacent a lens of the optical coupler.

Example 2. The photonic IC assembly of Example 1, wherein the plug alignment structures extend above the top surface of the optical coupler.

Example 3. The photonic IC assembly of Example 1, wherein the plug alignment structures are recessed into the top surface of the optical coupler.

Example 4. The photonic IC assembly of Example 1, wherein at least two of the plug alignment structures are disposed opposite sides of the lens of the optical coupler.

Example 5. The photonic IC assembly of Example 1, wherein the plug alignment structures are disposed on a common bolt circle around the lens of the optical coupler.

Example 6. The photonic IC assembly of Example 1, wherein the plug alignment structures have a circular, polygonal, or oblong sectional area.

Example 7. The photonic IC assembly of Example 1, wherein the plug alignment structures are trenches.

Example 8. The photonic IC assembly of Example 1, wherein the top surface of the photonic IC die and the bottom surface of the optical coupler having mating die/coupler alignment structures.

Example 9. The photonic IC assembly of Example 1 further including: a plug retaining clamp coupled to the top surface of the photonic IC die.

Example 10. A co-packaged integrated circuit (IC) device including: a substrate; at least one integrated circuit (IC) die mounted to a top surface of the substrate; a photonic IC (PIC) die mounted to the top surface of the substrate, the photonic IC die having a waveguide and photonic circuity, the photonic circuity coupled to functional circuitry of the IC die through the substrate; and an optical coupler having a top surface and a bottom surface, the bottom surface of the optical coupler bonded to the PIC die, the top surface of the optical coupler having plug alignment structures disposed adjacent a lens of the optical coupler, the optical coupler configured to couple light to the photonics circuitry of the photonic IC through the waveguide.

Example 11. The co-packaged IC device of Example 10, wherein the plug alignment structures extend above the top surface of the optical coupler.

Example 12. The co-packaged IC device of Example 10, wherein the plug alignment structures are recessed into the top surface of the optical coupler.

Example 13. The co-packaged IC device of Example 10, wherein at least two of the plug alignment structures are disposed opposite sides of the lens of the optical coupler.

Example 14. The co-packaged IC device of Example 10, wherein the plug alignment structures are disposed on a common bolt circle around the lens of the optical coupler.

Example 15. The co-packaged IC device of Example 10, wherein the plug alignment structures have a circular, polygonal, or oblong sectional area.

Example 16. The co-packaged IC device of Example 10, wherein the plug alignment structures are trenches.

Example 17. The co-packaged IC device of Example 10, wherein the top surface of the photonic IC die and the bottom surface of the optical coupler having mating die/coupler alignment structures.

Example 18. The co-packaged IC device of Example 10 further including: a plug having coupler alignment structures disposed on a bottom surface of the plug configured to mate with the plug alignment structures formed of the coupler, the plug having a mirror positioned to direct light, from fiber optics terminating in the plug, between the coupler alignment structures through the lens of the coupler and to the waveguide of the PIC die.

Example 19. The co-packaged IC device of Example 18 further including: a plug retaining clamp coupled to the top surface of the photonic IC die, the plug retaining clamp configured to secure the plug over the coupler.

Example 20. A co-packaged integrated circuit (IC) device including: a substrate; at least one integrated circuit (IC) die mounted to a top surface of the substrate; a photonic IC (PIC) die mounted to the top surface of the substrate, the photonic IC die having a waveguide and photonic circuity, the waveguide configured to direct light to the photonic circuity, the photonic circuity coupled to functional circuitry of the IC die through the substrate; an optical coupler having a top surface and a bottom surface, the bottom surface of the optical coupler and the PIC die having mating alignment structures that restrict lateral movement between the optical coupler and the PIC die, the top surface of the optical coupler having plug alignment structures disposed adjacent a lens of the optical coupler; and a plug having coupler alignment structures disposed at an end of a spacer extending from a bottom surface of the plug mating with the plug alignment structures of the coupler, the spacers setting an air gap between the plug and coupler, the plug having a mirror positioned to direct light, from fiber optics terminating in the plug, between the coupler alignment structures through the lens of the coupler and to the waveguide of the PIC die.

Example 21. A method for coupling of light between a photonic integrated circuit (PIC) assembly and optical fibers, the method including: inserting an alignment structure extending from one of an optical coupler and a photonic IC with an alignment structure formed in the other of the optical coupler and the photonic IC; and bonding the optical coupler and the photonic IC to form the PIC assembly.

Example 22. The method of Example 21, wherein inserting an alignment structure extending from one of the optical coupler and the photonic IC with an alignment structure formed in the other of the optical coupler and the photonic IC further includes: inserting one or more posts extending from the optical coupler into a trench formed in the photonic IC.

Example 23. The method of Example 21, wherein inserting an alignment structure extending from one of the optical coupler and the photonic IC with an alignment structure formed in the other of the optical coupler and the photonic IC further includes: inserting one or more posts extending from the photonic IC into a trench formed in the optical coupler.

While the foregoing is directed to embodiments of the present invention, other and further embodiments of the invention may be devised without departing from the basic scope thereof, and the scope thereof is determined by the claims that follow.

What is claimed is:

1. A photonic integrated circuit (IC) assembly comprising:
a photonic IC die; and
an optical coupler having a top surface and a bottom surface, the bottom surface of the optical coupler bonded to the photonic IC die, the top surface of the optical coupler having plug alignment structures disposed adjacent a lens of the optical coupler.

2. The photonic IC assembly of claim 1, wherein the plug alignment structures extend above the top surface of the optical coupler.

3. The photonic IC assembly of claim 1, wherein the plug alignment structures are recessed into the top surface of the optical coupler.

4. The photonic IC assembly of claim 1, wherein at least two of the plug alignment structures are disposed opposite sides of the lens of the optical coupler.

5. The photonic IC assembly of claim 1, wherein the plug alignment structures are disposed on a common bolt circle around the lens of the optical coupler.

6. The photonic IC assembly of claim 1, wherein the plug alignment structures have a circular, polygonal, or oblong sectional area.

7. The photonic IC assembly of claim 1, wherein the plug alignment structures are trenches.

8. The photonic IC assembly of claim 1, wherein the top surface of the photonic IC die and the bottom surface of the optical coupler having mating die/coupler alignment structures.

9. The photonic IC assembly of claim 1 further comprising:
a plug retaining clamp coupled to the top surface of the photonic IC die.

10. A co-packaged integrated circuit (IC) device comprising:
a substrate;
at least one integrated circuit (IC) die mounted to a top surface of the substrate;
a photonic IC (PIC) die mounted to the top surface of the substrate, the photonic IC die having a waveguide and photonic circuity, the photonic circuity coupled to functional circuitry of the IC die through the substrate; and
an optical coupler having a top surface and a bottom surface, the bottom surface of the optical coupler bonded to the PIC die, the top surface of the optical coupler having plug alignment structures disposed adjacent a lens of the optical coupler, the optical coupler configured to couple light to the photonics circuitry of the photonic IC through the waveguide.

11. The co-packaged IC device of claim 10, wherein the plug alignment structures extend above the top surface of the optical coupler.

12. The co-packaged IC device of claim 10, wherein the plug alignment structures are recessed into the top surface of the optical coupler.

13. The co-packaged IC device of claim 10, wherein at least two of the plug alignment structures are disposed opposite sides of the lens of the optical coupler.

14. The co-packaged IC device of claim 10, wherein the plug alignment structures are disposed on a common bolt circle around the lens of the optical coupler.

15. The co-packaged IC device of claim 10, wherein the plug alignment structures have a circular, polygonal, or oblong sectional area.

16. The co-packaged IC device of claim 10, wherein the plug alignment structures are trenches.

17. The co-packaged IC device of claim 10, wherein the top surface of the photonic IC die and the bottom surface of the optical coupler having mating die/coupler alignment structures.

18. The co-packaged IC device of claim 10 further comprising:
a plug having coupler alignment structures disposed on a bottom surface of the plug configured to mate with the plug alignment structures formed of the coupler, the plug having a mirror positioned to direct light, from fiber optics terminating in the plug, between the coupler alignment structures through the lens of the coupler and to the waveguide of the PIC die.

19. The co-packaged IC device of claim 18 further comprising:
a plug retaining clamp coupled to the top surface of the photonic IC die, the plug retaining clamp configured to secure the plug over the coupler.

20. A co-packaged integrated circuit (IC) device comprising:
a substrate;
at least one integrated circuit (IC) die mounted to a top surface of the substrate;
a photonic IC (PIC) die mounted to the top surface of the substrate, the photonic IC die having a waveguide and photonic circuity, the waveguide configured to direct light to the photonic circuity, the photonic circuity coupled to functional circuitry of the IC die through the substrate;
an optical coupler having a top surface and a bottom surface, the bottom surface of the optical coupler and the PIC die having mating alignment structures that restrict lateral movement between the optical coupler and the PIC die, the top surface of the optical coupler having plug alignment structures disposed adjacent a lens of the optical coupler; and
a plug having coupler alignment structures disposed at an end of a spacer extending from a bottom surface of the plug mating with the plug alignment structures of the coupler, the spacers setting an air gap between the plug and coupler, the plug having a mirror positioned to direct light, from fiber optics terminating in the plug, between the coupler alignment structures through the lens of the coupler and to the waveguide of the PIC die.
